(19) United States
(12) Patent Application Publication
(10) Pub. No.: US 2009/0083140 A1
(43) Pub. Date: Mar. 26, 2009

(54) NON-INTRUSIVE, CONTEXT-SENSITIVE INTEGRATION OF ADVERTISEMENTS WITHIN NETWORK-DELIVERED MEDIA CONTENT

(75) Inventor: Thomas Phan, San Jose, CA (US)

Correspondence Address: FIALA & WEAVER, P.L.L.C.;C/O INTELLEVATE, P.O. BOX 52050, MINNEAPOLIS, MN, 55402, US

(73) Assignee: YAHOO! INC., Sunnyvale, CA (US)

(21) Appl. No.: 11/860,637

(22) Filed: Sep. 25, 2007

(51) Int. Cl. G06Q 30/00

(52) U.S. Cl. 705/14

(57) ABSTRACT

A system, method and computer program product for integrating an advertisement within network-delivered media content is described. In accordance with one implementation, media content is retrieved for delivery to an end user, wherein the media content type is one of text, graphic, video or audio. The media content is analyzed to identify an advertisement insertion location within the media content. An advertisement is inserted within the media content at the advertisement insertion location, wherein the advertisement type is the same as the media content type. The media content is then delivered to the end user via a network.

### BACKGROUND OF THE INVENTION

1. Field of the Invention

The invention generally relates to the delivery of media content and advertisements over a network, such as the Internet.

2. Background

Advertisers wish to deliver advertisements via data communication networks such as the Internet. For example, advertisers wish to display advertisements on Web pages. These advertisements typically consist of text advertisements or graphic advertisements, but may also consist of video or audio advertisements as well.

Such advertisements may be ignored by users, or the advertisements may be blocked by software executing on the same computing platform as the Web browser used to view the Web page. Text and graphic advertisements are often placed on the side of a Web page away from the focal point of the user's attention, which typically lies at the center of the Web page. Thus, such advertisements tend to be ignored. For advertisement delivery companies, the problem of advertisements being ignored or blocked is significant because such companies may make a sizeable portion of their revenue via cost-per-click (CPC) contracts, and if the users ignore or block advertisements then clicks will not result.

Current challenges for delivering advertisements on Web pages include: (1) placing advertisements on Web pages that cannot be ignored or blocked; (2) placing advertisements subtly with low intrusion on the user experience; and (3) placing advertisements in a manner that fits semantically with the content of the Web page.

Current best practices for advertisement placement on Web pages follow a number of different schemes. Both text advertisements and graphic advertisements are commonly placed at the edges of the Web page body, for example on the top border or right border. Further, the delivered advertisements may be chosen to fit both the content of the Web page as well as the user viewing the Web page. So-called “content-match systems” attempt to analyze the Web page content and place relevant advertisements that match the content, while so-called “behavioral targeting systems” analyze past user behavior and try to deliver advertisements relevant to the user based on this analysis. However, none of these approaches are able to prevent advertisements from being ignored or blocked by an end user.

What is needed, then, is a means for placing advertisements on a Web page that reduces the likelihood that the advertisements will be ignored by a user and that prevents the advertisements from being blocked. The desired means should preferably place such advertisements in a subtle manner that minimizes any sense of intrusion by the user viewing the Web page. The desired means should also preferably place such advertisements in a manner that fits semantically with the content of the Web page. The desired means should be further be extendable to other methods of delivering advertisements over a network.

### BRIEF SUMMARY OF THE INVENTION

The present invention provides a means for integrating advertisements into network-delivered media content. In accordance with one aspect of the present invention, the advertisements are integrated in a manner that reduces the likelihood that the advertisements will be ignored by a user and that prevents the advertisements from being blocked by an end user system/device. In accordance with another aspect of the present invention, the advertisements are integrated within the media content in a subtle manner that minimizes any sense of intrusion by the user viewing the media content. In accordance with yet another aspect of the present invention, the advertisements are integrated in a manner that fits semantically with the media content.

In particular, a method is described herein for integrating an advertisement within network-delivered media content. In accordance with the method, media content is retrieved for delivery to an end user via a network, wherein the media content type is one of text, graphic, video or audio. The media content is analyzed to identify an advertisement insertion location within the media content. An advertisement is inserted within the media content at the advertisement insertion location, wherein the advertisement type is the same as the media content type. The media content, including the integrated advertisement, is then delivered to the end user via the network.

In accordance with a further embodiment of the method, a concept associated with the media content is identified and the advertisement is selected based on the concept associated with media content.

A system is also described herein. The system includes a media content database, an advertisement database, a media content and advertising integration system and a content delivery system. The media content and advertising integration system is coupled to the media content database and the advertisement database. The media content and advertising integration system is configured to retrieve media content from the media content database, wherein the media content type is one of text, graphic, video or audio, to analyze the media content to identify an advertisement insertion location within the media content, and to insert an advertisement from the advertisement database within the media content at the advertisement insertion location, wherein the advertisement type is the same as the media content type. The content delivery system is coupled to the media content and advertising integration system. The content delivery system is configured to deliver the media content, including the integrated advertisement, to the end user via a network.

In a further embodiment, the media content and advertising integration system includes matching logic. The matching logic is configured to identify a concept associated with the media content and to select the advertisement based on the concept associated with media content.

A computer program product is also described herein. The computer program product includes a computer-readable medium having computer program logic recorded thereon for enabling a processing unit to integrate an advertisement within network-delivered media content. The computer program logic includes first means, second means, third means and fourth means. The first means enable the processing unit to retrieve media content for delivery to an end user via a network, wherein the media content type is one of text, graphic, video or audio. The second means enable the processing unit to analyze the media content to identify an advertisement insertion location within the media content. The third means enable the processing unit to insert an advertisement within the media content at the advertisement insertion location, wherein the advertisement type is the same as the media content type. The fourth means enable the processing unit to deliver the media content to the end user via the network.

In a further embodiment, the computer program logic further includes means for enabling the processing unit to identify a concept associated with the media content and means for enabling the processing unit to select the advertisement based on the concept associated with media content.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of a system for integrating advertisements within network-delivered media content in accordance with an embodiment of the present invention.

FIG. 2 illustrates a flowchart of a method for integrating advertisements within network-delivered media content in accordance with an embodiment of the present invention.

FIG. 3 illustrates a flowchart of a method for selecting an advertisement for integration within requested media content based on a conceptual relationship between the selected advertisement and the requested media content in accordance with an embodiment of the present invention.

FIG. 4 is a block diagram of a portion of a system for integrating a text advertisement within network-delivered text content in accordance with an embodiment of the present invention.

FIG. 5 illustrates a flowchart of a method for integrating a text advertisement within network-delivered text content in accordance with an embodiment of the present invention.

FIG. 6A depicts an example display screen rendered by an end user system/device in a mode of operation in which no integration of text advertisements into text content has occurred.

FIG. 6B depicts an example display screen rendered by an end user system/device in a mode of operation in which integration of text advertisements into text content has occurred in accordance with an embodiment of the present invention.

FIG. 7 is a block diagram of a portion of a system for integrating a graphic advertisement within network-delivered graphic content in accordance with an embodiment of the present invention.

FIG. 8 illustrates a flowchart of a method for integrating a graphic advertisement within network-delivered graphic content in accordance with an embodiment of the present invention.

FIG. 9A depicts an example display screen rendered by an end user system/device in a mode of operation in which no integration of graphic advertisements into graphic content has occurred.

FIG. 9B depicts an example display screen rendered by an end user system/device in a mode of operation in which integration of a graphic advertisement into graphic content has occurred in accordance with an embodiment of the present invention.

FIG. 10 is a block diagram of an example computer system which may be used to implement an embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Integration of Advertisements within Network-Delivered Media Content in Accordance with an Embodiment of the Present Invention

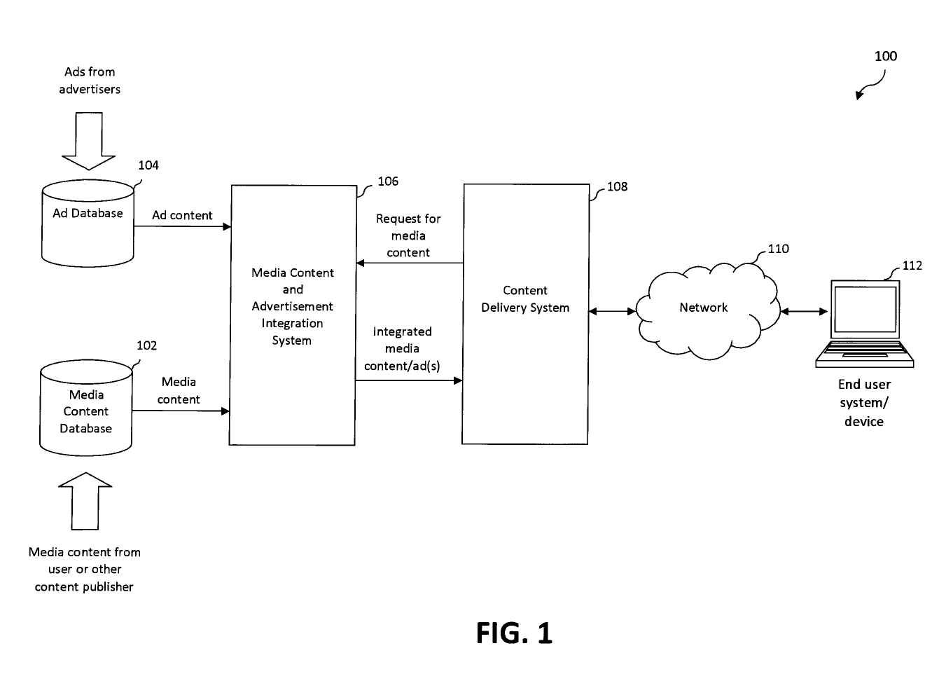

FIG. 1 is a high-level block diagram of a system 100 for integrating advertisements within network-delivered media content in accordance with an embodiment of the present invention. As shown in FIG. 1, system 100 includes a media content database 102, an advertisement database 104, a media content and advertisement integration system 106, a content delivery system 108, a network 110, and an end user system/device 112. Each of these elements of system 100 will now be described in detail.

Media content database 102 represents one or more storage devices or systems used to store media content for delivery to one or more end users. As used herein, the term “media content” refers to any type of content that may be viewed or played back by an end user. Such media content may comprise text, graphic, video or audio content. Examples of text content include the text of an e-mail to be displayed by an e-mail program or text to be displayed in the body of a Web page. An example of graphic content includes an image to be displayed in the body of a Web page. An example of video content includes a video file or video stream that is to be made accessible to an end user via a Web page or e-mail. An example of audio content includes an audio file or audio stream that is to be made accessible to an end user via a Web page or e-mail. However, these examples are not intended to be limiting and it is to be understood that the term media content as used herein is not limited to any particular type of media or to any particular form of network delivery.

As used herein, the term “media content” is not intended to encompass code used to display or play back content to an end user (e.g., HTML code used to display text or graphic images to an end user via a Web browser) or any data appended to such content for the purposes of transmitting the content over a network or for performing other processing tasks related to the content (e.g., packet headers or metadata associated with the content for the purposes of content handling).

The media content may be provided for storage in media content database 102 in accordance with any of a variety of well-known methods. For example, where the media content is e-mail text, the e-mail text may be transmitted by the sender of the e-mail to an e-mail service provider over the Internet. The e-mail service provider may then store the e-mail text in media content database 102 for subsequent retrieval by the intended recipient(s) of the e-mail. As another example, where the media content is text or graphic content for display on a Web page, the text or graphic content may be uploaded by a user or other content publisher to a Web hosting service over the Internet. The Web hosting service provider may then store the text or graphic content in media content database 102 for use in publishing a Web page. However, these examples are not intended to be limiting and other methods may be used to provide media content for storage in database 102.

Advertisement database 104 represents one or more storage devices or systems used to store advertisements for selective integration with media content stored in database 102 in a manner to be described in more detail herein. As used herein, the term “advertisement” refers to information that that may be viewed or played back by a user and that is intended to draw the user's attention to a product or service. An advertisement may comprise a text, graphic, video or audio advertisement.

The advertisements may be provided for storage in advertisement database 104 in accordance with any of a variety of well-known methods. For example, the advertisements may be provided by an advertiser over a network such as the Internet or on a computer-readable medium such as an optical or floppy disk for uploading into database 104. However, these examples are not intended to be limiting and other methods may be used to provide advertisements for storage in database 104.

Media content and advertisement integration system 106 is a system that is configured to receive requests for media content, to retrieve the requested media content from media content database 102, and to selectively integrate one or more advertisements from advertisement database 104 into the requested media content in a manner to be described in more detail herein.

Content delivery system 108 is a system that is configured to receive requests for media content from various remote end user systems or devices and to pass such requests onto media content and advertisement integration system 106 for handling. Content delivery system 108 is configured to communicate with the remote end user systems/devices via a data communication network 110, such as the Internet. Content delivery system 108 is further configured to receive integrated media content and advertisements from media content and advertisement integration system 106 and to deliver such content to one or more of the end user systems/devices. An exemplary remote end user system/device 112 is shown in FIG. 1; however, persons skilled in the relevant art(s) will readily appreciated that content delivery system 108 may be configured to communicate with a plurality of such end user systems/devices.

Each of media content and advertisement integration system 106 and content delivery system 108 may be implemented as one or more software programs executing on one or more computing platforms, such as one or more server computers. Alternatively, media content and advertisement integration system 106 and content delivery system 108 may be implemented as a single program executing on a single computing platform.

In one embodiment, content delivery system 108 comprises a Web server configured to receive requests for media content from Web browsers executing on the remote end user systems/devices. In another embodiment, content delivery system 108 comprises an e-mail server configured to receive requests for media content from e-mail programs executing on the remote end user systems/devices. However, these examples are not intended to limit the present invention and content delivery system 108 may comprise any system configured to receive requests for media content and to deliver requested media content over a network.

End user system/device 112 is intended to represent any system or device capable of requesting media content over a network and of displaying such media content or playing such media content back to an end user. For example, and without limitation, end user system/device 112 may comprise a personal computer (PC), a console, a network-enabled television, a television and set-top box, or a handheld or mobile electronic device such as a laptop computer, a personal digital assistant (PDA), a mobile telephone, a digital audio or multimedia player.

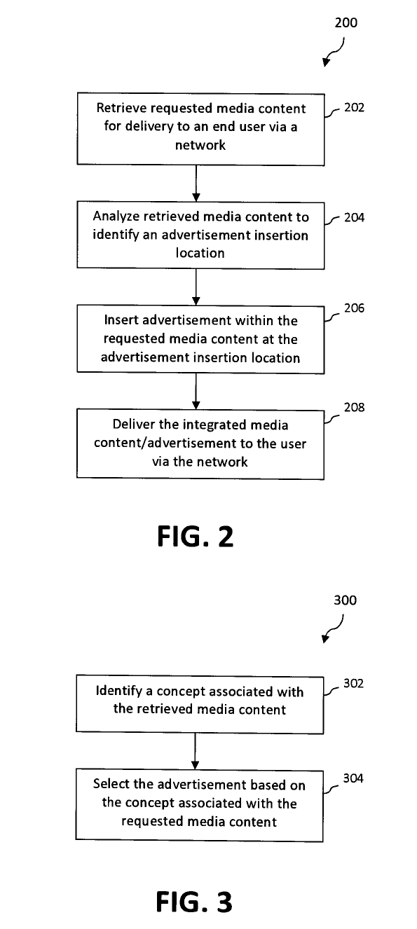

The general manner in which system 100 operates to integrate advertisements within network-delivered media content will now be described with reference to flowchart 200 of FIG. 2. Although the method of flowchart 200 will be described with reference to the elements of system 100, persons skilled in the relevant art(s) will readily appreciate that the method is not limited to that implementation.

As shown in FIG. 2, the method of flowchart 200 begins at step 202, in which media content and advertisement integration system 106 retrieves media content from media content database 102 for delivery to an end user via a network. In an embodiment, media content and advertisement integration system 106 retrieves the media content responsive to receiving a request for the media content from the end user. The request is received by content delivery system 108 from end user system/device 112 and forwarded to media content and advertisement integration system 106.

At step 204, media content and advertisement integration system 106 analyzes the retrieved media content to identify an advertisement insertion location within the retrieved media content. The manner in which the advertisement insertion location is identified may depend upon the type of media content that has been retrieved. For example, in an embodiment described in more detail below in which the retrieved media content is text content, the advertisement insertion location is identified by analyzing the text content to identify a location between two words or two sentences at which a text advertisement may be inserted. As another example, in an embodiment described in more detail below in which the retrieved media content is graphic content, the advertisement insertion location is identified by analyzing the graphic content to identify a suitable area within the graphic content to insert a graphic advertisement. In each case, the advertisement insertion location is chosen to integrate the advertisement within the retrieved media content in a way that is as subtle and non-intrusive as possible.

At step 206, media content and advertisement integration system 106 inserts an advertisement within the retrieved media content at the advertisement insertion location. The advertisement is of the same media type as the retrieved media content. For example, if the retrieved media content is text content, the advertisement is a text advertisement. Likewise, if the retrieved media content is graphic, video or audio content, then the advertisement is a graphic, video or audio advertisement respectively. The manner in which the advertisement is inserted within the retrieved media content may also be dependent on the type of media content that has been retrieved. This concept will be further explained with reference to several example embodiments described below.

At step 208, the retrieved media content, which now includes the integrated advertisement, is delivered to end user system/device 112 via network 110. In system 100, this step is performed by content delivery system 108.

Although the method of flowchart 200 describes the insertion of only a single advertisement into the media content retrieved during step 202, persons skilled in the relevant art(s) will readily appreciate that steps 204 and 206 of flowchart 200 may be repeated any number of times to insert any number of additional advertisements within the retrieved media content. Thus, the invention is by no means limited to inserting a single advertisement within retrieved media content.

In accordance with one embodiment of the present invention, the manner in which media content and advertisement integration system 106 selects an advertisement from advertisement database 104 for insertion into retrieved media content is based on identifying a conceptual relationship between the retrieved media content and the selected advertisement. By ensuring the existence of such a conceptual relationship, media content and advertisement integration system 106 increases the likelihood that the selected advertisement will be of interest to the end user and will also increase the likelihood that the selected advertisement will be perceived by the end user as fitting within the context of the originally-requested media content.

FIG. 3 illustrates a flowchart 300 of one method for selecting an advertisement for integration within retrieved media content based on a conceptual relationship between the retrieved media content and the selected advertisement. Although the method of flowchart 300 will be described with continued reference to the elements of system 100, persons skilled in the relevant art(s) will readily appreciate that the method is not limited to that implementation.

As shown in FIG. 3, the method of flowchart 300 beings at step 302, in which media content and advertisement integration system 106 identifies a concept associated with retrieved media content. The manner in which the concept is identified may depend upon the type of media content that has been retrieved. For example, in an embodiment described in more detail below in which the retrieved media content is text content, the concept is identified by analyzing words within the text content itself. As another example, in an embodiment described in more detail below in which the retrieved media content is graphic content, the concept is identified by analyzing one or more keywords associated with the graphic content.

At step 304, media content and advertisement integration system 106 selects an advertisement from advertisement database 104 based on the identified concept associated with the retrieved media content. The manner in which the advertisement is selected may also depend upon the type of media content that has been retrieved. For example, in an embodiment described in more detail below in which the retrieved media content is text content, the advertisement is selected by matching one or more keywords associated with the advertisement to words within the text of the retrieved text content. As another example, in an embodiment described in more detail below in which the retrieved media content is graphic content, the advertisement is selected by matching one or more keywords associated with the advertisement to one or more keywords associated with the retrieved graphic content.

More specific implementations of system 100 will now be described. In particular, in Section B, an implementation of system 100 that integrates text advertisements into text content will be described. In Section C, an implementation of system 100 that integrates graphic advertisements into graphic content will be described. In Section D, further alternative implementations will be described. In Section E, an example computer system that may be used to implement an embodiment of the present invention will be described. In Section F, some concluding remarks are provided.

### B. Integration of Text Advertisements within Network-Delivered Text Content in Accordance with an Embodiment of the Present Invention

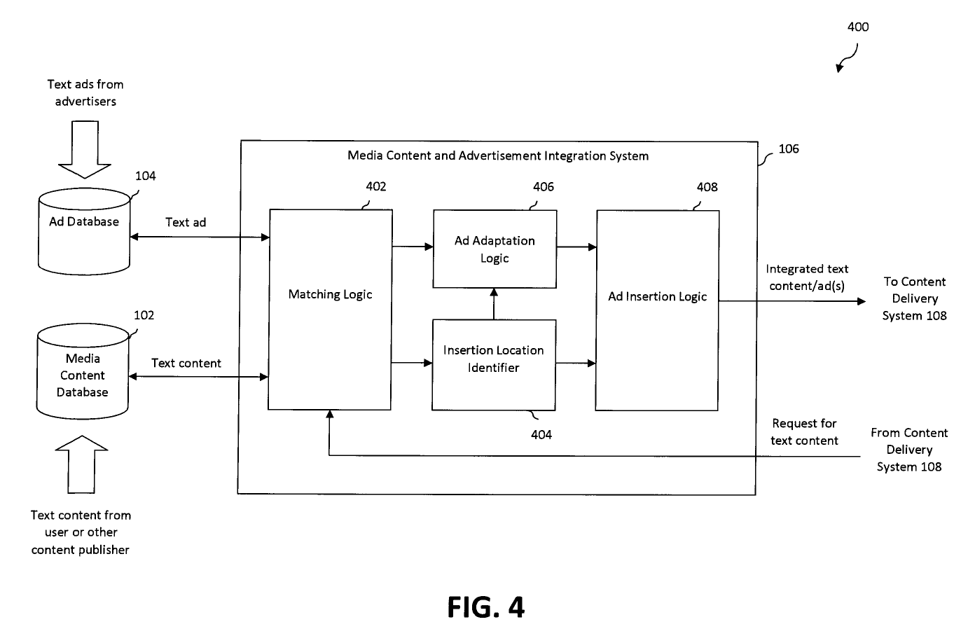

FIG. 4 is a block diagram of a portion of a system 400 for integrating text advertisements within network-delivered text content in accordance with an embodiment of the present invention. System 400 is represented as a specific implementation of system 100 of FIG. 1. In particular, within system 400, media content and advertisement integration system 106 is shown as including various elements that are configured to perform functions relating to the integration of text advertisements within text content. As shown in FIG. 4, these elements include matching logic 402, an insertion location identifier 404, advertisement adaptation logic 406 and advertisement insertion logic 408. Each of these elements will now be described in detail.

Matching logic 402 is configured to retrieve requested text content from media content database 102 and to select one or more text advertisements from advertisement database 104 for integration within the retrieved text content based on a matching algorithm. As will be discussed in more detail below, this matching algorithm may include identifying a concept associated with the retrieved text content and then selecting one or more text advertisements from advertisement database 104 based on the identified concept.

Insertion location identifier 404 is configured to analyze the retrieved text content to identify an insertion location within the retrieved text content at which to insert each selected text advertisement. As will be discussed in more detail below, this may include identifying an interstitial location between words or sentences of the retrieved text content at which to insert a selected text advertisement.

Advertisement adaptation logic 406 is configured to adapt each selected text advertisement to ensure that the text advertisement fits both grammatically and semantically within the retrieved text content.

Advertisement insertion logic 408 is configured to insert each adapted text advertisement received from advertisement adaptation logic 406 within the retrieved text content at a corresponding insertion location identified by insertion location identifier 404. Advertisement insertion logic 408 is further configured to pass the integrated text content and advertisement(s) to content delivery system 108 for delivery to an end user over network 110.

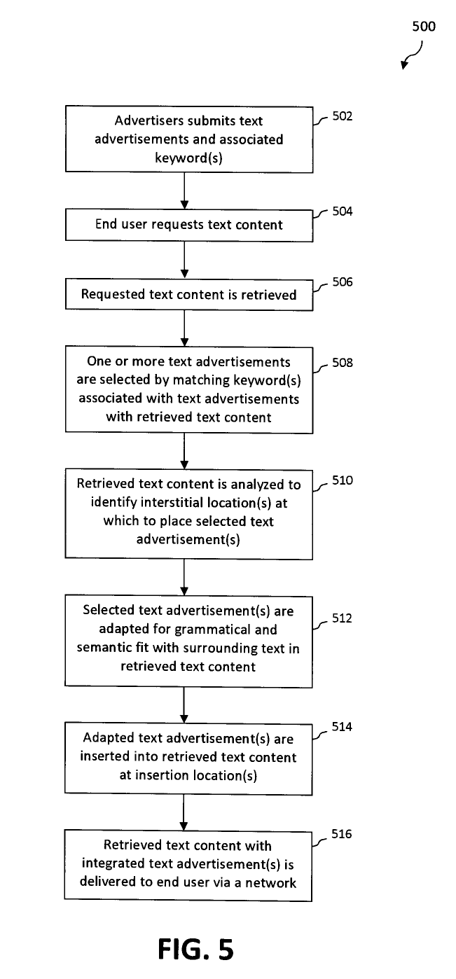

The manner in which system 400 operates to integrate text advertisements within network-delivered text content will now be described with reference to flowchart 500 of FIG. 5. Although the method of flowchart 500 will be described with reference to the elements of system 400, persons skilled in the relevant art(s) will readily appreciate that the method is not limited to that implementation.

As shown in FIG. 5, the method of flowchart 500 begins at step 502, in which advertisers submit text advertisements and one or more keywords associated with each text advertisement. The text advertisements and associated keywords are stored in advertisement database 104. The keywords associated with each text advertisement are selected to identify at least one concept associated with each text advertisement. For example, if a text advertisement relates to automobiles, selected keywords may include “automobile,” “car,” “vehicle,” or the like. The selection of keywords to represent underlying concepts or subject matter of text is well-known to persons skilled in the relevant art(s).

At step 504, an end user requests text content. The request is transmitted over network 110 to content delivery system 108. Content delivery system 108 passes the request to matching logic 402 within media content and advertisement integration system 106. The requested text content may comprise, for example, the text of an e-mail to be displayed by an e-mail program. As another example, the requested text content may comprise text to be displayed in the body of a Web page, such as a news article, book/movie review, “blog,” or any other text-based subject matter presented within the context of a Web page.

In an alternate embodiment of the present invention not represented in flowchart 500 of FIG. 5, the text content is not requested by an end user at all, but is sent to the end user responsive to some other command or event. For example, the text content may comprise the text of an instant message sent from another user to the end user. As another example, the text content may comprise a portion of a Web feed that is automatically delivered to the end user on a periodic basis after the end users subscribes to the feed.

At step 506, matching logic 402 retrieves the requested text content from media content database 102.

At step 508, matching logic 402 selects one or more text advertisements from advertisement database 104 by comparing the keyword(s) associated with each text advertisement stored therein with words from the retrieved text content. By perform keyword matching in this manner, one or more text advertisements can be selected that have the most similar conceptual content to the retrieved text content based on the keyword matching algorithm. The use of keyword matching to select content containing desired subject matter is well-known to persons skilled in the relevant art(s), and is commonly used by search engines and other information retrieval systems.

Of course, keyword matching is only one method of searching for text advertisements that matches the retrieved text content. Numerous other techniques are available in the domain of information filtering and information retrieval for searching for conceptually-relevant information from among a plurality of text-based information sources. Many of these techniques generate representations of each text-based information source based on a model. These models may include, for example and without limitation, set theoretic models (including standard Boolean models, extended Boolean models and fuzzy retrieval), algebraic models (including vector space models, topic-based vector space models, enhanced topic-based vector space models, and latent semantic indexing) and probabilistic models (including binary independence retrieval, probabilistic relevance models, language models, divergence from randomness models, and Latent Dirichlet allocation).

At step 510, insertion location identifier 404 analyzes the retrieved text content to identify a location within the retrieved text content at which to place each selected text advertisement. Where more than one text advertisement has been selected, insertion location identifier 404 identifies a different insertion location for each selected text advertisement.

In an embodiment, insertion location identifier 404 identifies an insertion location by parsing the text of the retrieved text content to identify an interstitial location between two consecutive words or sentences of the retrieved text content at which to place the selected text advertisement. For example, if the selected text advertisement comprises a full sentence, insertion location identifier 404 may identify an insertion location between two consecutive sentences of the retrieved text content at which to place the full sentence. As another example, if the selected text advertisement comprises parenthetical information, insertion location identifier 404 may identify an insertion location between two consecutive words of the retrieved text content at which to place the parenthetical information.

The insertion location may also be selected to ensure that the inserted text advertisement is conceptually relevant to adjacent text within the retrieved text content. This may be achieved, for example, by choosing an interstitial location that immediately follows the text upon which the matching and selection function of step 508 was based (in other words, the text in the retrieved text content that matched the keywords associated with the selected text advertisement). By inserting a selected text advertisement next to conceptually-relevant text in the retrieved text content, the selected text advertisement is more likely to fit semantically within the retrieved text content. As a result, the logical flow of the resulting integrated text content and advertisement will be improved.

At step 512, advertisement adaptation logic 406 adapts each of the one or more selected text advertisements for both grammatical and semantic fit with adjacent text in the retrieved text content. The adjacent text is determined based on the insertion location(s) identified by insertion location identifier 404 in the manner previously described.

Advertisement adaptation logic 406 adapts a selected text advertisement for grammatical fit with adjacent text by ensuring that various rules of grammar are not violated when the adapted text advertisement is inserted within the retrieved media content at the insertion location. Automated grammar checking software of the kind already in widespread use in the area of word processing may be applied to perform this function.

Advertisement adaptation logic 406 adapts a selected text advertisement for semantic fit with adjacent text by ensuring that the adapted text advertisement includes one or more words or represents one or more concepts that are also included or represented in the adjacent text. This may be performed, for example, by ensuring that at least one of the keywords used to select the text advertisement appears in the adapted text advertisement.

At step 514, advertisement insertion logic 408 inserts each adapted text advertisement produced by advertisement adaptation logic 406 into the retrieved text content at a corresponding insertion location provided by insertion location identifier 404. At step 516, the retrieved text content with the integrated text advertisement(s) is then delivered to the end user via network 110. This step is performed by content delivery system 108.

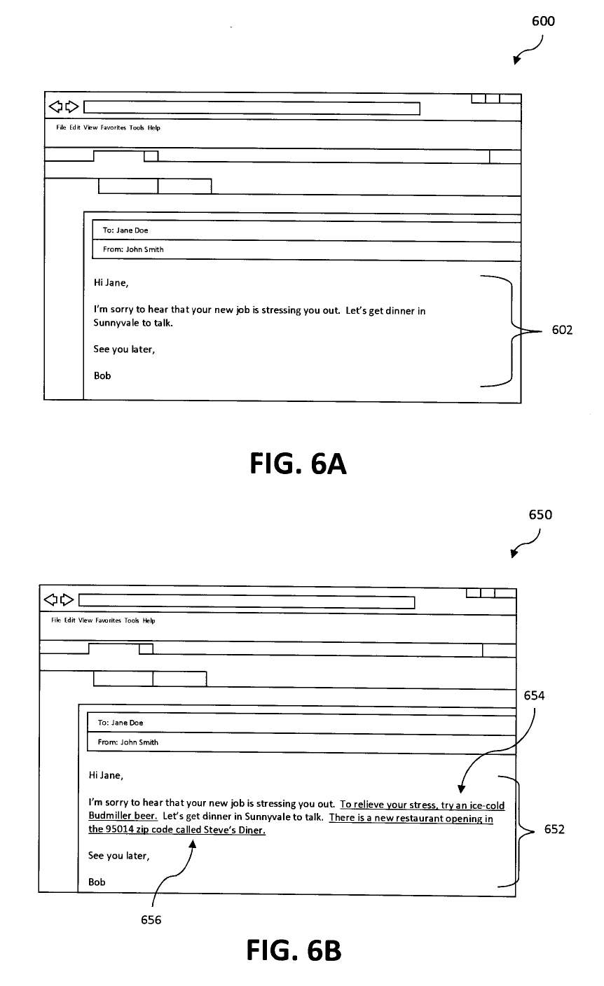

One manner in which text content may be modified in accordance with the foregoing method to integrate one or more text advertisements is illustrated by FIG. 6A and FIG. 6B. In particular, FIG. 6A depicts an example display screen 600 rendered by end user system/device 112 in a mode of operation in which no integration of text advertisements into text content has occurred. As shown in this figure, unmodified text content 602 representing an e-mail message has been delivered to end user system/device 112 and has been displayed in display screen 600 by a program, such as a Web browser or e-mail program, executing on end user system/device 112. The text content states “Hi Jane, I'm sorry to hear that your new job is stressing you out. Let's get dinner in Sunnyvale to talk. See you later, Bob.”

FIG. 6B depicts an example display screen 650 rendered by end user system/device 112 in a mode of operation in which integration of text advertisements into text content has occurred. As shown in this figure, integrated text content and text advertisements 652 representing an e-mail message has been delivered to end user system/device 112 and has been displayed in display screen 650 by a program, such as a Web browser or e-mail program, executing on end user system/device 112. In this example, the original e-mail text has been modified by media content and advertisement integration system 106 to include a first text advertisement 654 and a second text advertisement 656.

First text advertisement 654 states “To relieve your stress, try an ice-cold Budmiller beer.” First text advertisement 654 is inserted immediately after the original sentence that states “I'm sorry to hear that your new job is stressing you out.” Because of the manner in which media content and advertising integration system 106 operates, first text advertisement 654 comprises a grammatically correct sentence that logically follows from the preceding sentence and that semantically fits within the context of the original e-mail text. For example, the concept of trying an ice-cold Budmiller beer to relieve stress as conveyed by first text advertisement 654 is conceptually related to the concept of the preceding sentence relating to the e-mail recipient being “stressed out” by her new job.

Second text advertisement 656 states “There is a new restaurant opening in the 95014 zip code called Steve's Diner.” Second text advertisement 656 is inserted immediately after the original sentence that states “Let's get dinner in Sunnyvale to talk.” Because of the manner in which media content and advertising integration system 106 operates, second text advertisement 656 comprises a grammatically correct sentence that logically follows from the preceding sentence and that semantically fits within the context of the original e-mail text. For example, the identification of a restaurant within the 95014 zip code as conveyed by second text advertisement 656 is conceptually related to the concept of getting dinner in Sunnyvale as conveyed by the preceding sentence.

Because first text advertisement 654 and second text advertisement 656 are delivered to end user system/device 112 as an integrated part of the original text content, it is more likely that the end user will pay attention to the text advertisements. This is because the text advertisements form a part of the e-mail that the end user will be reading. Furthermore, because first text advertisement 654 and second text advertisement 656 are delivered to end user system/device 112 as an integrated part of the original text content, the text advertisements cannot be detected by conventional ad blocking software that may be running on end user system/device 112.

FIG. 6A and FIG. 6B are intended to represent only a single example of the manner in which text advertisements may be integrated within network-delivered text content in accordance with an embodiment of the present invention. Thus, these figures should not be used to limit the present invention.

### C. Integration of Graphic Advertisements within Network-Delivered Graphic Content in Accordance with an Embodiment of the Present Invention

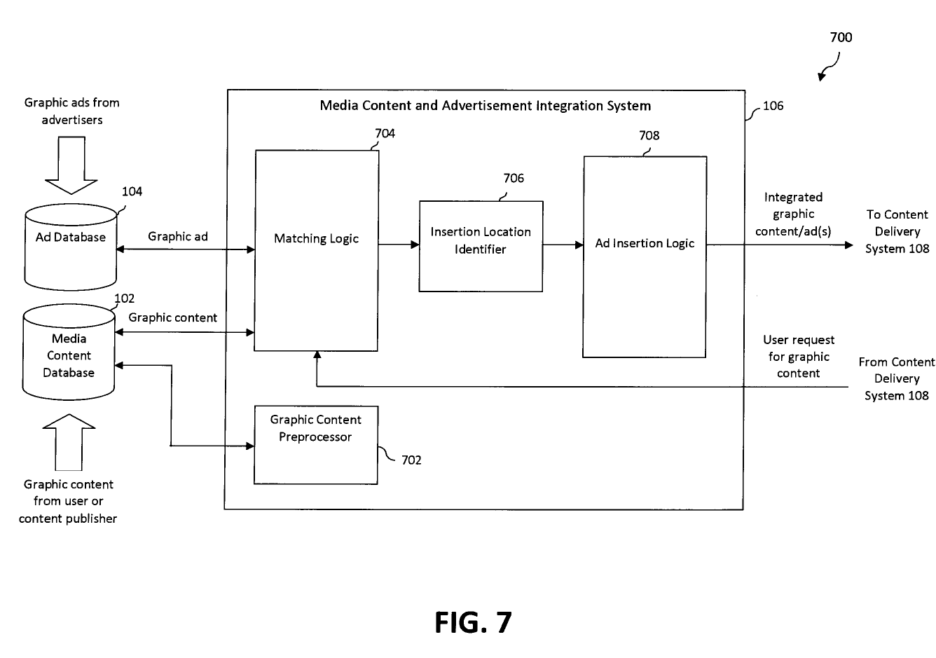

FIG. 7 is a block diagram of a portion of a system 700 for integrating graphic advertisements within network-delivered graphic content in accordance with an embodiment of the present invention. System 700 is represented as a specific implementation of system 100 of FIG. 1. In particular, within system 700, media content and advertisement integration system 106 is shown as including various elements that are configured to perform functions relating to the integration of graphic advertisements within graphic content. As shown in FIG. 7, these elements include a graphic content preprocessor 702, matching logic 704, an insertion location identifier 706 and advertisement insertion logic 708. Each of these elements will now be described in detail.

Graphic content preprocessor 702 is configured to access graphic content stored in media content database 102 and to perform certain tasks to prepare such graphic content for processing by matching logic 704 and insertion location identifier 706. For example, as will be discussed in more detail herein, graphic content preprocessor 702 may identify items of graphic content that are candidates for graphic advertisement insertion, categorize the candidate items of graphic content, associate one or more keyword(s) with each candidate item of graphic content, and optionally identify one or more graphic advertisement insertion locations within each candidate item of graphic content. If graphic content preprocessor 702 associates a candidate item of graphic content with a category specification, one or more keywords, or one or more insertion locations, then the category specification, keyword(s) and insertion location(s) are stored in association with the candidate item of graphic content in media content database 102 for use in future processing.

Matching logic 704 is configured to retrieve requested graphic content from media content database 102 and to select one or more graphic advertisements from advertisement database 104 for integration within the retrieved graphic content based on a matching algorithm. As will be discussed in more detail below, this matching algorithm may include identifying a concept associated with the retrieved graphic content and then selecting one or more graphic advertisements from advertisement database 104 based on the identified concept.

Insertion location identifier 706 is configured to identify an insertion location within the retrieved graphic content at which to insert each selected graphic advertisement. Insertion location identifier 706 may identify insertion locations based on an analysis of the retrieved graphic content, based on information previously associated with the retrieved graphic content by graphic content preprocessor 702, or both. As will be discussed in more detail below, identifying an insertion location within the retrieved graphic content may include identifying a suitable area within the retrieved graphic content to insert a selected graphic advertisement.

Advertisement insertion logic 708 is configured to insert each graphic advertisement selected by matching logic 704 within the retrieved graphic content at a corresponding insertion location identified by insertion location identifier 706. Advertisement insertion logic 708 is further configured to pass the integrated graphic content and advertisement(s) to content delivery system 108 for delivery to an end user over network 110.

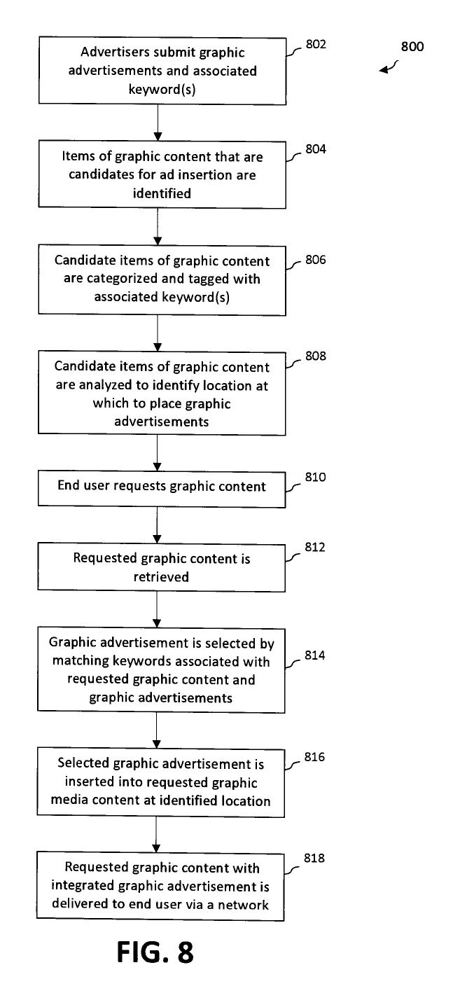

The manner in which system 700 operates to integrate graphic advertisements within network-delivered graphic content will now be described with reference to flowchart 800 of FIG. 8. Although the method of flowchart 800 will be described with reference to the elements of system 700, persons skilled in the relevant art(s) will readily appreciate that the method is not limited to that implementation.

As shown in FIG. 8, the method of flowchart 800 begins at step 802, in which advertisers submit graphic advertisements and one or more keywords associated with each graphic advertisement. The graphic advertisements and associated keywords are stored in advertisement database 104. The keywords associated with each graphic advertisement are selected to identify at least one concept associated with each graphic advertisement. For example, if a graphic advertisement comprises an image of an automobile, selected keywords may include “automobile,” “car,” “vehicle,” or the like. The selection of keywords to represent underlying concepts or subject matter of graphic content is well-known to persons skilled in the relevant art(s).

At step 804, graphic content preprocessor 702 accesses graphic content stored in media content database 104 and identifies items of graphic content that are candidates for ad insertion. The determination of whether or not an item of graphic content is a candidate for ad insertion may be based on any of a variety of factors, including but not limited to whether the graphic content includes one or more areas that are well-suited for graphic advertisement insertion. Such areas, for example, may be areas exceeding a particular size that are white or predominantly white and/or are areas of low contrast. Other areas may be identified by finding regions with smooth texture, low grain or noise level, and a wide plane of focus. Other factors concerning each item of graphic content may be analyzed to determine whether or not the item of graphic content is a candidate for ad insertion. Also, although step 804 is described herein as being performed automatically by graphic content preprocessor 702, persons skilled in the relevant art(s) will readily appreciate that this step may also be performed by human beings as well.

At step 806, graphic content preprocessor 702 categorizes the candidate items of graphic content identified in step 804 and associates one or more keywords with each candidate item. The organization of the candidate items of graphic content into categories facilitates a matching function performed by matching logic 704 as will be described in more detail herein. The keywords associated with each candidate item are selected to identify at least one concept associated with the item and are also used to facilitate the matching function. In one embodiment of the present invention, the keywords associated with each candidate item are not generated by graphic content preprocessor 702 but are derived from metadata previously associated with each item by another user, computer program or device. In a further embodiment, the categorization of and/or assignment of keywords to each candidate item is performed by one or more human beings rather than by graphic content preprocessor 702.

At step 808, graphic content preprocessor 702 analyzes each candidate item of graphic content to identify one or more locations at which a graphic advertisement may be inserted. As noted above, a desirable insertion location may comprise an area that exceeds a particular size and that is white or predominantly white and/or is an area of low contrast. However, any number of criteria may be used to identify the insertion locations. In an alternate embodiment, the identification of insertion location is performed by one or more human beings rather than by graphic content preprocessor 702.

After the performance of steps 804, 806 and 808, if graphic content preprocessor 702 has associated a candidate item of graphic content with a category specification, one or more keywords, or one or more insertion locations, then the category specification, keyword(s) and insertion location(s) are stored in association with the candidate item of graphic content in media content database 102 for use in future processing.

At step 810, an end user requests graphic content. The request is transmitted over network 110 to content delivery system 108. Content delivery system 108 passes the request to matching logic 704 within media content and advertisement integration system 106. The requested graphic content may comprise, for example, an image to be displayed in the body of a Web page or e-mail. In an alternate embodiment of the present invention not represented in flowchart 800 of FIG. 8, the graphic content is not requested by an end user at all, but is sent to the end user responsive to some other command or event.

At step 812, matching logic 704 retrieves the requested graphic content from media content database 102. For the purposes of the remaining description of flowchart 800, it will be assumed that the retrieved graphic content has been identified as a candidate for graphic advertisement insertion by graphic content preprocessor 702.

At step 814, matching logic 704 selects one or more graphic advertisements from advertisement database 104 by comparing the keyword(s) associated with each graphic advertisement stored therein with the keyword(s) associated with the retrieved graphic content. By performing keyword matching in this manner, one or more graphic advertisements can be selected that have the most similar conceptual content to the retrieved graphic content based on the keyword matching algorithm. The use of keyword matching to select content containing desired subject matter is well-known to persons skilled in the relevant art(s), and is commonly used by search engines and other information retrieval systems.

At step 816, ad insertion logic 708 inserts each graphic advertisement selected by matching logic 402 into the retrieved graphic content at a corresponding insertion location provided by insertion location identifier 706. The graphic advertisement may be overlaid onto the graphic media content and flattened into one image. This process is well-known to persons skilled in the relevant art(s). Insertion location identifier 706 may identify insertion locations based on an analysis of the retrieved graphic content, based on information previously associated with the retrieved graphic content by graphic content preprocessor 702, or both.

At step 818, the retrieved graphic content with the integrated graphic advertisement(s) is then delivered to the end user via network 110. This step is performed by content delivery system 108.

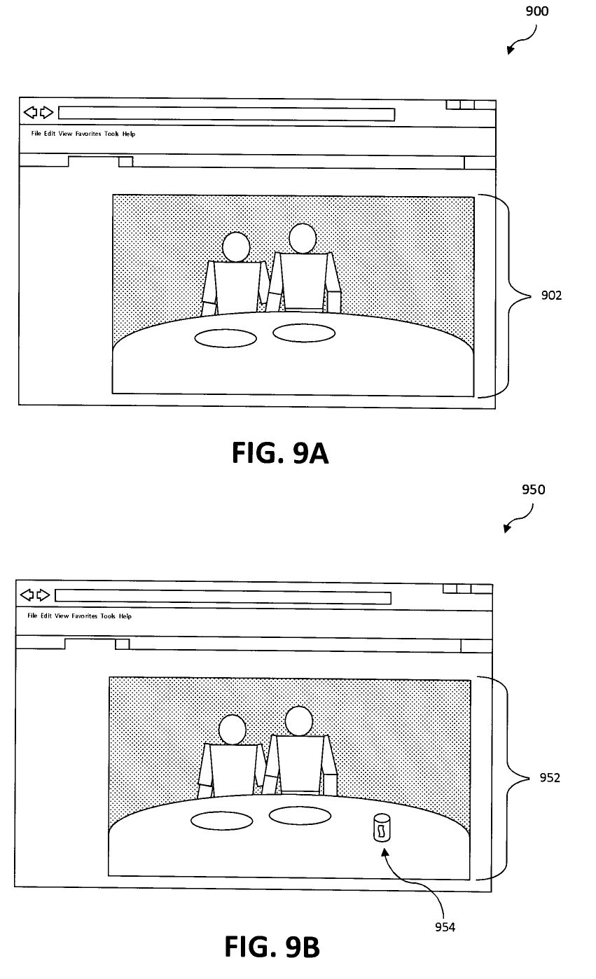

One manner in which graphic content may be modified in accordance with the foregoing method to integrate a graphic advertisement is illustrated by FIG. 9A and FIG. 9B. In particular, FIG. 9A depicts an example display screen 900 rendered by end user system/device 112 in a mode of operation in which no integration of graphic advertisements into graphic content has occurred. As shown in this figure, unmodified graphic content 902 representing a digital photograph has been delivered to end user system/device 112 and has been displayed in display screen 900 by a program, such as a Web browser, executing on end user system/device 112. The digital photograph shows two individuals in a restaurant sitting before a table set with two plates.

FIG. 9B depicts an example display screen 950 rendered by end user system/device 112 in a mode of operation in which integration of a graphic advertisement into graphic content has occurred. As shown in this figure, integrated graphic content and graphic advertisement 952 representing a digital photograph has been delivered to end user system/device 112 and has been displayed in display screen 950 by a program, such as a Web browser, executing on end user system/device 112. In this example, the original digital photograph has been modified by media content and advertisement integration system 106 to include a graphic advertisement 954.

In the example of FIG. 9B, graphic advertisement 954 comprises an image of a soft drink can with a distinct logo. Because of the manner in which media content and advertisement integration system 106 operates, graphic advertisement 954 is inserted in a location within digital photograph 952 where it is clearly visible and does not obscure any other objects or people within the photograph. In particular, it is placed on a white region of the photograph corresponding to a white table cloth. Furthermore, graphic advertisement 954 is inserted in a location that appears natural given the context of the digital photograph-namely, on a table with other objects. Also, because of the manner in which media content and advertising integration system 106 operates, graphic advertisement 106, which conceptually relates to soft drinks specifically and beverages generally, is semantically related to the digital photograph, which shows two individuals in a restaurant—an environment in which beverages are normally consumed.

Because graphic advertisement 952 is delivered to end user system/device 112 as an integrated part of the original graphic content, it is more likely that the end user will pay attention to the graphic advertisement. This is because the graphic advertisement forms a part of the digital photograph that the end user is interested in viewing. Furthermore, because graphic advertisement 952 is delivered to end user system/device 112 as an integrated part of the original graphic content, the graphic advertisement cannot be detected by conventional ad blocking software that may be running on end user system/device 112.

FIG. 9A and FIG. 9B are intended to represent only a single example of the manner in which graphic advertisements may be integrated within network-delivered graphic content in accordance with an embodiment of the present invention. Thus, these figures should not be used to limit the present invention.

### D. Integration of Advertisements within Network-Delivered Media Content in Accordance with Alternate Embodiments of the Present Invention

Although specific example implementations of the present invention have been described above in which text advertisements are integrated into network-delivered text content and in which graphic advertisements are integrated into graphic advertisements, the present invention is not limited to these embodiments. As noted in section A, above, the concepts of the present invention also extend to encompass the integration of video advertisements into network-delivered video content and the integration of audio advertisements into network-delivered audio content.

In an embodiment of the present invention in which video advertisements are integrated into network-delivered video content, video content may be stored in a video content database and preprocessed to determine conceptual subject matter of the video content and to identify one or more insertion locations in the video content. Video content retrieved for an end user may then be matched to video advertisements stored in a video advertisement database to select one or more video advertisements for insertion. The video advertisements and insertion locations are chosen so that each video advertisement visually and logically blends in with the video content. The selected video advertisement(s) may then be inserted within the retrieved video content at the identified insertion location(s). The integrated video content and video advertisement(s) may then be delivered to an end user via a network.

In an embodiment of the present invention in which audio advertisements are integrated into network-delivered audio content, audio content may be stored in an audio content database and preprocessed to determine conceptual subject matter of the audio content and to identify one or more insertion locations in the audio content. Audio content retrieved for an end user may then be matched to audio advertisements stored in an audio advertisement database to select one or more audio advertisements for insertion. The audio advertisements and insertion locations may be chosen so that each audio advertisement blends in with the audio content from an auditory and logical perspective. The selected audio advertisement(s) may then be inserted within the retrieved audio content at the identified insertion location(s). The integrated audio content and audio advertisement(s) may then be delivered to an end user via a network.

### C. Example Computer System Implementation

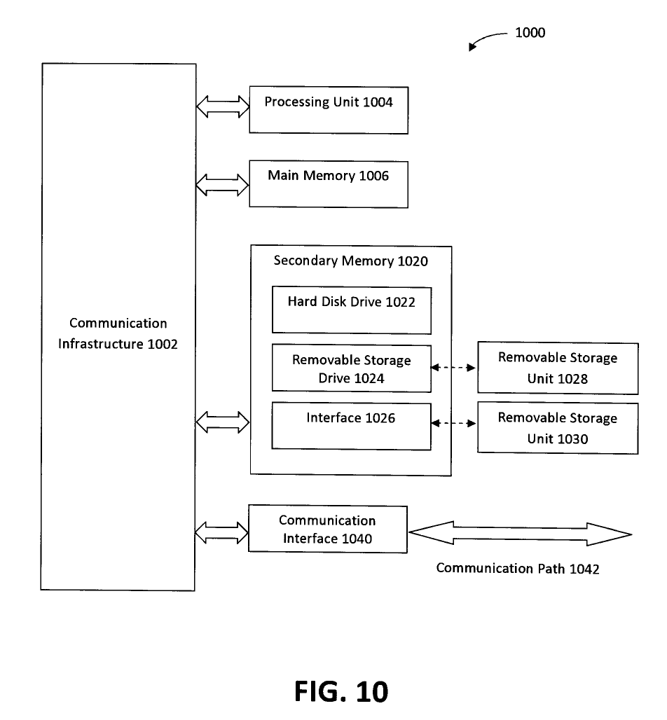

Many of the elements of systems 100, 400 and 700 as well as many of the steps of flowcharts 200, 300, 500 and 800 may be implemented using any well-known processor-based computer system. An example of such a computer system 1000 is depicted in FIG. 10.

As shown in FIG. 10, computer system 1000 includes a processing unit 1004 that includes one or more processors. Processor unit 1004 is connected to a communication infrastructure 1002, which may comprise, for example, a bus or a network.

Computer system 1000 also includes a main memory 1006, preferably random access memory (RAM), and may also include a secondary memory 1020. Secondary memory 1020 may include, for example, a hard disk drive 1022, a removable storage drive 1024, and/or a memory stick. Removable storage drive 1024 may comprise a floppy disk drive, a magnetic tape drive, an optical disk drive, a flash memory, or the like. Removable storage drive 1024 reads from and/or writes to a removable storage unit 1028 in a well-known manner. Removable storage unit 1028 may comprise a floppy disk, magnetic tape, optical disk, or the like, which is read by and written to by removable storage drive 1024. As will be appreciated by persons skilled in the relevant art(s), removable storage unit 1028 includes a computer usable storage medium having stored therein computer software and/or data.

In alternative implementations, secondary memory 1020 may include other similar means for allowing computer programs or other instructions to be loaded into computer system 1000. Such means may include, for example, a removable storage unit 1030 and an interface 1026. Examples of such means may include a program cartridge and cartridge interface (such as that found in video game devices), a removable memory chip (such as an EPROM, or PROM) and associated socket, and other removable storage units 1030 and interfaces 1026 which allow software and data to be transferred from the removable storage unit 1030 to computer system 1000.

Computer system 1000 may also include a communications interface 1040. Communications interface 1040 allows software and data to be transferred between computer system 1000 and external devices. Examples of communications interface 1040 may include a modem, a network interface (such as an Ethernet card), a communications port, a PCMCIA slot and card, or the like. Software and data transferred via communications interface 1040 are in the form of signals which may be electronic, electromagnetic, optical, or other signals capable of being received by communications interface 1040. These signals are provided to communications interface 1040 via a communications path 1042. Communications path 1042 carries signals and may be implemented using wire or cable, fiber optics, a phone line, a cellular phone link, an RF link and other communications channels.

As used herein, the terms “computer program medium” and “computer usable medium” are used to generally refer to media such as removable storage unit 1028, removable storage unit 1030, a hard disk installed in hard disk drive 1022, and signals received by communications interface 1040. Computer program medium and computer useable medium can also refer to memories, such as main memory 1006 and secondary memory 1020, which can be semiconductor devices (e.g., DRAMs, etc.). These computer program products are means for providing software to computer system 1000.

Computer programs (also called computer control logic, programming logic, or logic) are stored in main memory 1006 and/or secondary memory 1020. Computer programs may also be received via communications interface 1040. Such computer programs, when executed, enable the computer system 1000 to implement features of the present invention as discussed herein. Accordingly, such computer programs represent controllers of the computer system 1000. Where the invention is implemented using software, the software may be stored in a computer program product and loaded into computer system 1000 using removable storage drive 1024, interface 1026, or communications interface 1040.

The invention is also directed to computer program products comprising software stored on any computer useable medium. Such software, when executed in one or more data processing devices, causes a data processing device(s) to operate as described herein. Embodiments of the present invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, zip disks, tapes, magnetic storage devices, optical storage devices, MEMs, nanotechnology-based storage device, etc.), and communication mediums (e.g., wired and wireless communication networks, local area networks, wide area networks, intranets, etc.).

### D. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for integrating an advertisement within network-delivered media content, comprising:
retrieving media content for delivery to an end user via a network, wherein the media content type is one of text, graphic, video or audio;
analyzing the media content to identify an advertisement insertion location within the media content;
inserting an advertisement within the media content at the advertisement insertion location, wherein the advertisement type is the same as the media content type; and
delivering the media content to the end user via the network.

2. The method of claim 1, wherein the media content is text content and wherein analyzing the media content to identify an advertisement insertion location comprises analyzing the text content to identify a location between two words or two sentences at which a text advertisement may be inserted.

3. The method of claim 2, further comprising:
performing a semantic analysis of text in the text content adjacent to the advertisement insertion location; and
adapting the text advertisement based on the semantic analysis.

4. The method of claim 1, wherein the media content is graphic content and wherein analyzing the media content to identify an advertisement insertion location comprises analyzing the graphic content to identify a suitable area within the graphic content to insert an advertising image.

5. The method of claim 1, further comprising:
identifying a concept associated with the media content;
selecting the advertisement based on the concept associated with media content.

6. The method of claim 5, wherein the media content is text content, wherein identifying a concept associated with the media content comprises analyzing words in the text content, and wherein selecting the advertisement based on the concept associated with media content comprises:
analyzing one or more keywords associated with the advertisement; and
selecting the advertisement based on a match between one or more of the keyword(s) associated with the advertisement and one or more words in the text content.

7. The method of claim 5, wherein the media content is graphic content, wherein identifying a concept associated with the media content comprises analyzing one or more keywords associated with the graphic content, and wherein selecting the advertisement based on the concept associated with media content comprises:
analyzing one or more keywords associated with the advertisement; and
selecting the advertisement based on a match between one or more of the keyword(s) associated with the advertisement and one or more of the keyword(s) associated with the graphic content.

8. A system, comprising:
a media content database;
an advertisement database;
a media content and advertising integration system coupled to the media content database and the advertisement database, the media content and advertising integration system configured to retrieve media content from the media content database, wherein the media content type is one of text, graphic, video or audio, to analyze the media content to identify an advertisement insertion location within the media content, and to insert an advertisement from the advertisement database within the media content at the advertisement insertion location, wherein the advertisement type is the same as the media content type; and
a content delivery system coupled to the media content and advertising integration system, the content delivery system configured to deliver the media content to the end user via a network.

9. The system of claim 8, wherein the media content is text content and wherein the media content and advertising integration system comprises:
an insertion location identifier configured to analyze the text content to identify a location between two words or two sentences at which a text advertisement may be inserted.

10. The system of claim 9, wherein the media content and advertising integration system further comprises:
ad adaptation logic configured to perform a semantic analysis of text in the text content adjacent to the advertisement insertion location and to adapt the text advertisement based on the semantic analysis.

11. The system of claim 8, wherein the media content is graphic content and wherein the media content and advertising integration system comprises:
an insertion location identifier configured to analyze the graphic content to identify a suitable area within the graphic content to insert an advertising image.

12. The system of claim 8, wherein the media content and advertising integration system comprises:
matching logic configured to identify a concept associated with the media content and to select the advertisement based on the concept associated with media content.

13. The system of claim 12, wherein the media content is text content, and wherein the matching logic is configured to analyze words in the text content, to analyze one or more keywords associated with the advertisement, and to select the advertisement based on a match between one or more of the keyword(s) associated with the advertisement and one or more words in the text content.

14. The system of claim 12, wherein the media content is graphic content, wherein the matching logic is configured to analyze one or more keywords associated with the graphic content, to analyze one or more keywords associated with the advertisement, and to select the advertisement based on a match between one or more of the keyword(s) associated with the advertisement and one or more of the keyword(s) associated with the graphic content.

15. A computer program product comprising a computer-readable medium having computer program logic recorded thereon for enabling a processing unit to integrate an advertisement within network-delivered media content, wherein the computer program logic comprises:
first means for enabling the processing unit to retrieve media content for delivery to an end user via a network, wherein the media content type is one of text, graphic, video or audio;
second means for enabling the processing unit to analyze the media content to identify an advertisement insertion location within the media content;
third means for enabling the processing unit to insert an advertisement within the media content at the advertisement insertion location, wherein the advertisement type is the same as the media content type; and
fourth means for enabling the processing unit to deliver the media content to the end user via the network.

16. The computer program product of claim 15, wherein the media content is text content and wherein the second means comprises means for enabling the processing unit to analyze the text content to identify a location between two words or two sentences at which a text advertisement may be inserted.

17. The computer program product of claim 16, wherein the computer program logic further comprises:
means for enabling the processing unit to perform a semantic analysis of text in the text content adjacent to the advertisement insertion location; and
means for enabling the processing unit to adapt the text advertisement based on the semantic analysis.

18. The computer program product of claim 15, wherein the media content is graphic content and wherein the second means comprises means for enabling the processing unit to analyze the graphic content to identify a suitable area within the graphic content to insert an advertising image.

19. The computer program product of claim 15, wherein the computer program logic further comprises:
means for enabling the processing unit to identify a concept associated with the media content; and
means for enabling the processing unit to select the advertisement based on the concept associated with media content.

20. The computer program product of claim 19, wherein the media content is text content, wherein the means for enabling the processing unit to identify a concept associated with the media content comprises means for enabling the processing unit to analyze words in the text content, and wherein the means for enabling the processing unit to select the advertisement based on the concept associated with media content comprises:
means for enabling the processing unit to analyze one or more keywords associated with the advertisement; and
means for enabling the processing unit to select the advertisement based on a match between one or more of the keyword(s) associated with the advertisement and one or more words in the text content.

21. The computer program product of claim 19, wherein the media content is graphic content, wherein the means for enabling the processing unit to identify a concept associated with the media content comprises means for enabling the processing unit to analyze one or more keywords associated with the graphic content, and wherein the means for enabling the processing unit to select the advertisement based on the concept associated with media content comprises:
means for enabling the processing unit to analyze one or more keywords associated with the advertisement; and
means for enabling the processing unit to select the advertisement based on a match between one or more of the keyword(s) associated with the advertisement and one or more of the keyword(s) associated with the graphics content.
